(19) United States
(12) Patent Application Publication
(10) Pub. No.: US 2002/0002954 A1
(43) Pub. Date: Jan. 10, 2002

(54) Cat litter box

(76) Inventor: Emilio Ramon Goitiandia, Bilbao (ES)

Correspondence Address: OSTROLENK FABER GERB & SOFFEN, 1180 AVENUE OF THE AMERICAS, NEW YORK, NY, 100368403

(21) Appl. No.: 09/864,512

(22) Filed: May 24, 2001

(30) Foreign Application Priority Data
May 24, 2000 (ES) 20001386

(51) Int. Cl. A01K 29/00

(52) U.S. Cl. 119/165

(57) ABSTRACT

A cat litter box having a right angle rectangular prismatic configuration formed from a rigid cardboard base including a bottom and upstanding side walls joined to the bottom at fold lines and an impermeable laminar covering of plastic sheet material over the opposite surfaces of the 5 cardboard base. The covering is slightly longer and wider than the base and the sheets are joined at the marginal regions beyond the edges of the base. The panels defining the walls and attached to the bottom define open areas between adjacent walls. When the walls are folded up, the excess covering plastic material is folded over and is adhered to the walls, defining closure flaps and holding the walls upright.

### BACKGROUND OF THE INVENTION

The present invention relates to a cat litter box for containing an absorbent material, generally in the form of sand or the like, with special characteristics, for offering the animal a means and place for relieving itself.

Traditional cat litter boxes consist of a tray made of plastic material, such as PVC, of generally rectangular contour and with relatively low height walls.

These litter boxes present two major drawbacks. The first drawback is their lack of hygiene, because even if they are cleaned regularly, the plastic used in their construction ultimately deteriorates, allowing the encrustation of residues which are impossible to remove, despite the use of strong products such as bleach. These deposits are real foci of micro-organisms which are harmful to the health of the animal and, more importantly, to all those living in its environment. The second drawback is the difficulty of handling the litter boxes for cleaning, because in view of the size of traditional litter boxes, they are difficult to manipulate because they do not easily fit into a standard domestic sink. As a result, they frequently have to be cleaned in a bath tub. Whether they are cleaned in a bath tub or in a sink, they can give rise to contamination and, in any case, it is unpleasant for anyone to wash the tray in the same places as are used for family hygiene.

The foregoing means that litter-box cleanliness is frequently disregarded, which eventually produces foul smells and causes the litter box to be rejected by the animal, who may then prefer to relieve itself outside the litter box. This is especially delicate for cats, as they are scrupulously clean animals who prefer to use any corner in preference to entering a soiled enclosure.

### SUMMARY OF THE INVENTION

A subject of the present invention is a cat litter box which eliminates the hygiene and cleaning problems discussed above.

To this end, the litter box of the invention is designed as a disposable article, allowing it to be replaced with sufficient frequency so that hygiene problems do not arise, and this without the need for cleaning traditional litter boxes.

According to the present invention, the litter box is constructed from a template which is comprised of a rigid cardboard base and an impermeable laminar covering of plastic material which extends over both surfaces of the base.

The cardboard base comprises a sheet or base which includes a rectangular central zone that defines the bottom of the box, and which extends from the peripheral edges of the bottom into smaller rectangular panels which are folded up to define side walls of the box to be formed. The panels defining the bottom and the side walls are separated by fold lines which facilitate making-up the assembly.

The laminar covering over the base is comprised of two sheets having contours or dimensions slightly larger than that of the sheets which form the cardboard base. These two covering sheets extend over both surfaces of the base and their peripheral margins extend beyond the rectangular panels, where they are joined together at the edges of the sheets, enclosing the cardboard base between the sheets in a close-fitting manner. The two sheets have zones which form the covering that is superposed on the angle portions or open spaces defined between each two consecutive folded up walls of the cardboard base. When the assembly is completed, these zones at these portions of the covering will define closure flaps. In these portions, the two sheets are also joined along a line coinciding with the contour of the angle limited between each two consecutive walls of the cardboard base and along a diagonal line which crosses between the inner angle and the outer angle. These joining lines delimit a zone of the sheets which, when the box assembly is completed, are folded and disposed externally back onto upstanding the walls, to which they are fixed by means of an adhesive strip, or the like.

All the joining lines between the two sheets which form the impermeable covering may be obtained by heat-welding.

Characteristics and advantages of the litter box of the invention may be better understood from the following description which is made with reference to the appended drawings, which show a non-limiting illustrative embodiment.

### BRIEF DESCRIPTION OF THE DRAWINGS

FIG. 1 shows the layout of a blank for the cardboard base which forms part of the template of which the litter box of the invention is comprised.

FIG. 2 shows the layout of a blank for the laminar covering of the template which forms the litter box.

FIG. 3 shows the layout of the template comprised of the cardboard base of FIG. 1 overlaid with the covering of FIG. 2.

FIG. 4 is a partial section of the template, obtained along the sectional line IV-IV of FIG. 3.

FIG. 5 shows the template of FIG. 3 in the folded condition.

FIG. 6 is a perspective view of a litter box made from the template of FIG. 3.

### DESCRIPTION OF A PREFERRED EMBODIMENT

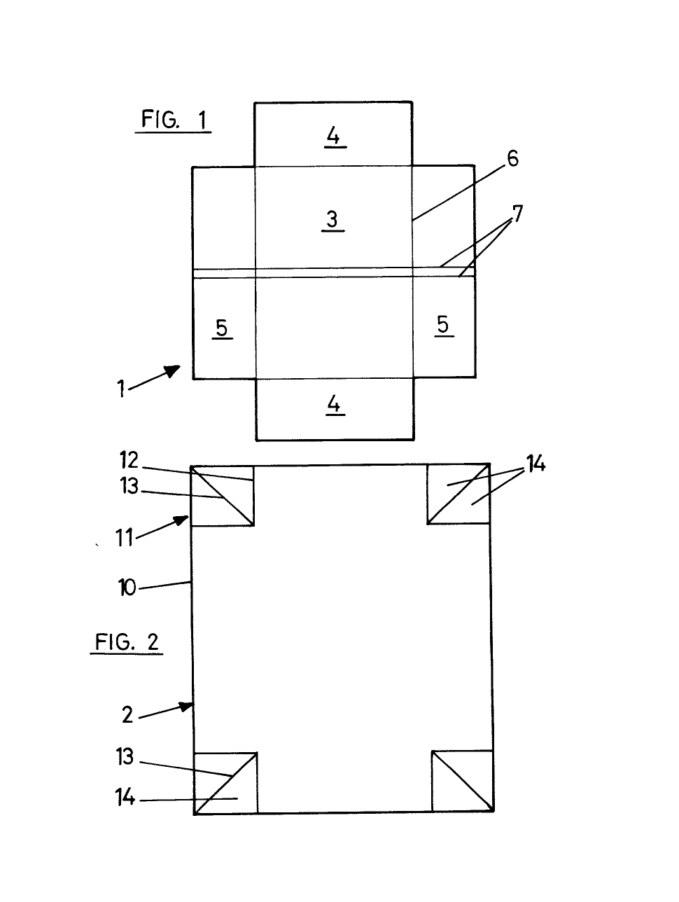

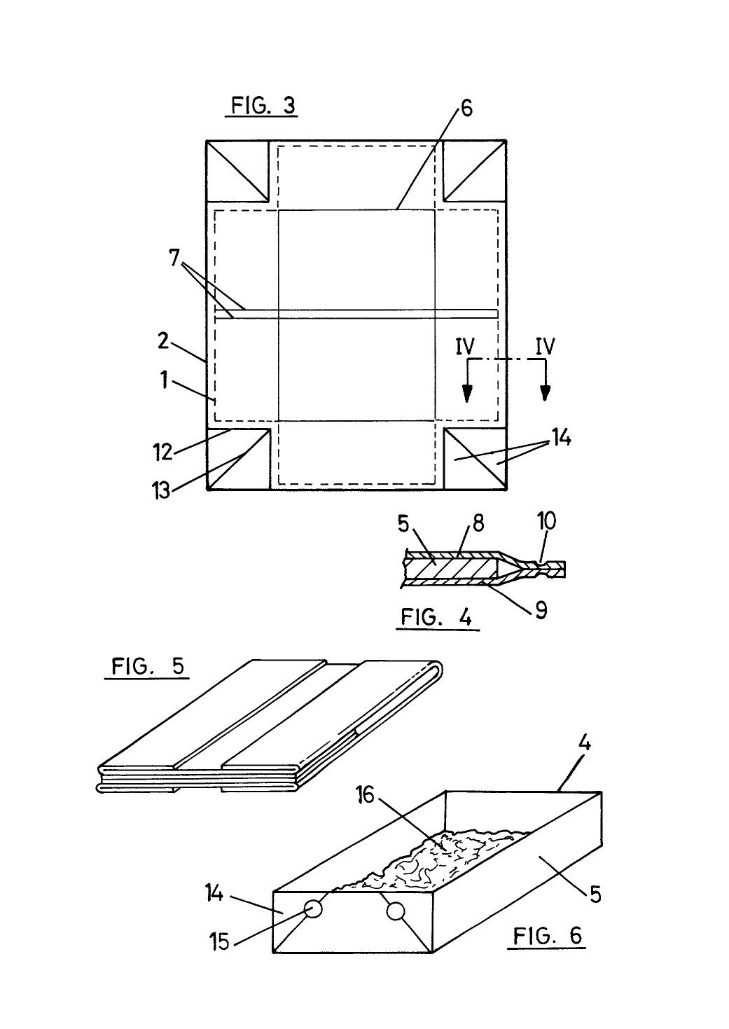

A litter box of the invention, as shown in FIG. 6, is constructed from a template comprised of a rigid cardboard base 1 (FIG. 1) and of an impermeable laminar covering of plastic material 2 (FIG. 2) placed over the opposite surfaces of the base (FIG. 3).

The cardboard base 1 is comprised of a plate or blank of rigid cardboard which includes a rectangular central zone 3, which will define the bottom of the litter box, surrounded by four smaller rectangular panels 4 and 5, which extend from the respective peripheral sides of the central zone and which will define the walls of the completed box. The panels are separated from the central zone 3 by folding lines 6. The central zone 3 and two opposite peripheral panels 5 may be traversed across their central part by a double fold line 7.

As seen in FIG. 2, the laminar element 2 is comprised of two preferably heat sealable sheets 8 and 9 with a contour or dimensions which are slightly greater than the maximum length and width of the cardboard base 1, so that the sheets 8 and 9 have marginal regions which project slightly beyond the edges of the peripheral panels 4 and 5 of the cardboard base 1. In this way, the sheets 8 and 9 contact one another along all of their edges. The edges are joined at that peripheral marginal regions 10, for example by heat-welding.

In the laminar covering, the sheets 8 and 9 are superposed over corner zones or empty spaces 11 which are defined between each two consecutive panels 4 and 5 of the cardboard base 1. In these corner zones, the two sheets 8 and 9 are joined or heat welded together by an angle line 12 which coincides with the contour of the angle limited between the two consecutive walls 4 and 5 of the cardboard base. In addition, the sheets 8 and 9 are also joined or heat welded by a diagonal line 13 which runs between the inner and outer angles of the corner zones. The weld lines 12 and 13 delimit zones 14 of the laminar covering which will be used for making up the assembly, as explained with reference to FIG. 6.

The template produced according to the invention, and as shown in FIG. 3, includes the cardboard base 1 which is protected by the impermeable laminar covering formed by sheets 8 and 9.

The reduced thicknesses of the sheets which form the impermeable covering enable the template of FIG. 3 to be folded along the lines 6 and 7 of the cardboard base of FIG. 1. For storage and transportation of the templates, they may be arranged as shown in FIG. 5, wherein the templates are folded via the two longitudinal fold lines 6 and then via the double transverse fold lines 7. The templates may be arranged thus in stacks, occupying a small space.

In order to make up a litter box, as shown in FIG. 6, the cardboard base is folded in the same direction at fold lines 6, until the panels are folded up to define walls 4 and 5 which are perpendicular to the base 3. The corner zones 11 of the covering are then folded at the diagonal joining lines 12, causing the portions 14 to project outward where they are applied against the outer surface of the respective adjacent small wall 4 to which they are joined, for example, by an adhesive strip or seal 15. The folded back portions 14 are seen in FIG. 6.

A litter box is thus obtained which has a right-angled rectangular prismatic configuration. Its strength is defined by the cardboard base 1, and it has an impermeable nature provided by the covering formed by the sheets of plastic 8 and 9. Sand 16 poured in the box offers an appropriate substrate for the cat to relieve itself. The absorbent material or sand 16 may be replaced in the litter box of the invention in the same way as in traditional trays. After the litter box has been reused a specified number of times, it may be folded up in order to be thrown out with the trash.

As the template which forms the litter box is covered with two layers preferably of a sealable plastic, its impermeability is guaranteed, offering the litter box a non-leak closure system.

Manufacture of the litter box requires no complex technology, since both the cardboard base 1 and the covering sheets applied thereover may be produced by traditional stamping and heat-welding machines.

Although the present invention has been described in relation to a particular embodiment thereof, many other variations and modifications and other uses will become apparent to those skilled in the art. It is preferred, therefore, that the present invention be limited to not by the specific disclosure herein, but only by the appended claims.

1. A cat litter box of a right angle, rectangular prismatic configuration comprised of a template comprised of a rigid material base having opposite surfaces and an impermeable laminar covering of plastic material extending over the surfaces of the base;
the base being shaped to define a bottom of the box with side edges and folded up side walls of the box attached at the side edges of the bottom, the base including fold lines at which it is folded to define the side walls, the side walls having outer edges opposite the fold lines;
the laminar covering comprising flexible sheets extending over the surfaces of the base, the sheets having length and width dimensions greater than the base and the sheets having marginal regions that project beyond edges of the side walls when the side walls are not folded up, the marginal regions of the sheets overlap, and the overlapping marginal regions of the sheets being joined together enclosing the base;
the base and the side walls being so shaped that before folding up the side walls on the respective fold lines, there are spaces between adjacent side walls, the flexible sheets extending over the spaces between the side walls, such that when the side walls are folded up on the respective fold lines, between each two adjacent walls there is a zone of the laminated sheets which is folded for defining closure flaps for being secured to hold the folded up walls.

2. The cat litter box of claim 1, wherein there are respective fold lines for and defining each of the walls and a double fold line extending transversely across the bottom of the base and across two of the walls, so that the box may be folded over along the double fold line.

3. The cat litter of claim 1, wherein the base is of rigid cardboard.

4. A cat litter box of right angle rectangular prismatic configuration, comprising:
a base including a rectangular bottom with four sides, the base having a respective rectangular panel at each of the four sides of the base, and each rectangular panel being joined at a respective fold line with the respective side of the base, such that when the rectangular panels are folded up around the respective fold lines, a box shape comprised of the base and the side walls is formed, the rectangular panels at the base each being separated from adjacent ones of rectangular panels by an open space which is reduced and closed when the panels are folded up around the fold lines;
the base having opposite surfaces; an impermeable laminar cover comprised of two sheets extending over both surfaces of the base, the sheets having a greater length and width dimension than the base and the sheets having peripheral margins which extend beyond the panels and are joined together defining a rectangular shape for the impermeable covering, the sheets having zones extending over the spaces between adjacent panels, the sheets being so shaped that when the panels at the base are folded up, closing the spaces between adjacent panels, the zones of the laminar covering that were over the spaces between adjacent panels are folded to form a respective closure flap between the adjacent walls.

5. The cat litter box of claim 4, wherein the laminar covering is of a plastic material.

6. The cat litter box of claim 5, wherein the base is of rigid cardboard.

7. The cat litter box of claim 4, wherein there are respective fold lines for and defining each of the panels and a double fold line extending transversely across the bottom of the base and across two of the panels, so that the box may be folded over along the double fold line.

8. The cat litter box of claim 4, wherein the sheets are attached at the marginal edges and along an inner angle line that coincides with the contours of the space between adjacent side walls and also along a diagonal line which crosses each space between adjacent side walls, with the attachments defining zones in of the sheets that, when the side walls are folded up at the fold lines, define flaps which are foldable against the adjacent walls to be adhered there.

9. The cat litter box of claim 8, wherein the laminar covering is a plastic material.

10. The cat litter box of claim 9, wherein the flaps are folded against the exterior of adhesive element is used for holding the flap to the walls.
